(19) United States
(12) Patent Application Publication
(10) Pub. No.: US 2009/0073043 A1
(43) Pub. Date: Mar. 19, 2009

(54) Apparatus for determining the location of a mobile node in a wireless system

(75) Inventor: Masanori Nozaki, Osaka (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/230,126

(22) Filed: Aug. 25, 2008

(30) Foreign Application Priority Data
Sep. 18, 2007 (JP) 2007-241147

(51) Int. Cl. G01S 3/02

(52) U.S. Cl. 342/450

(57) ABSTRACT

A wireless system has a set of frequency channels that can be used for communication between a mobile node and a set of anchor nodes. The position of the mobile node is estimated by measuring the power with which wireless signals transmitted by the mobile node are received at the anchor nodes. Each anchor node cyclically scans the frequency channels, and can therefore measure the received power of wireless signals transmitted on any one of the frequency channels. When the mobile node is engaged in a call, if the measured received power drops by at least a certain amount, a quantity is added to the measured value to compensate for effects such as signal blockage by the user's hand.

### BACKGROUND OF THE INVENTION

1. Field of the Invention

The present invention relates to the determination of the location of a mobile node in a wireless system employing multiple frequency channels.

2. Description of the Related Art

Methods of estimating the location of a mobile node by use of wireless signals are well known. One general type of method uses wireless signals transmitted to the mobile node, as in the global positioning system (GPS) and the Japanese personal handy phone system (PHS). These two systems, however, require the mobile node to receive signals from a plurality of earth-orbiting satellites or terrestrial base stations and do not always work well indoors, where the necessary signals may not be receivable.

Another general type of method uses wireless signals transmitted by the mobile node. One strategy is to measure the strength or power with which these wireless signals are received at a set of anchor nodes with known locations. The measured power varies (decreases) with the distance from the mobile node to the anchor nodes, so the measured power values can be used to infer the location of the mobile unit. One method employing this strategy is described by Yanagihara et al. in ‘IEEE 802.15.4 wo mochiita okunai ichi suitei shisutemu’ (‘The Indoor Location Estimation System using IEEE 802.15.4’), Institute of Electronics, Information and Communication Engineers of Japan, 3rd Sensor Network Conference, January 2006. A somewhat similar method is disclosed in U.S. Pat. No. 6,473,038 to Patwari et al. (and in corresponding Japanese Patent Application Publication No. 2005-507070).

The methods described by Yanagihara et al. and Patwari et al. can be used to determine the presence and location of wireless nodes in a local area network (LAN). Many wireless LANs now comply with the 802.11 family of standards established by the Institute of Electrical and Electronics Engineers (IEEE), however. In an IEEE 802.11 wireless network, these methods encounter the following problem.

An IEEE 802.11 wireless network makes use of a plurality of selectable frequency channels, with different channels generally being assigned to different anchor nodes in such a way as to avoid interference. A mobile node, however, transmits on only one frequency channel at a time. A wireless signal that is received by one anchor node may therefore be unreceivable by other nearby anchor nodes, which are the very nodes that need to measure the received power of the wireless signal in order to pin down the location of the mobile node. In this situation, accurately locating the mobile node becomes difficult or impossible. Providing each anchor node with extra receiving circuits so that it could receive wireless signals on all channels simultaneously would be an undesirable solution to this problem, as it would increase the size and cost of the anchor nodes.

### SUMMARY OF THE INVENTION

An object of the present invention is to estimate the location of a mobile node in a multi-frequency wireless system inexpensively, without requiring extra circuits for receiving measurement signals on multiple frequencies.

The invention provides a wireless communication control apparatus for use in the anchor nodes of a wireless system in which the location of a mobile node is estimated from wireless signals transmitted from the mobile node to the anchor nodes. The wireless communication control apparatus includes a receiving unit that receives wireless signals transmitted from the mobile node, a received power measurement unit that measures the received power of the wireless signals, and a measurement information generator for transmitting information including the received power values to a location estimation unit. The receiving unit scans a set of frequency channels by cyclically selecting the frequency channels at prescribed intervals.

The mobile node can be requested by the location estimation unit to transmit a series of wireless signals specifically for the purpose of location estimation. As the receiving unit scans the frequency channels, eventually it will encounter these transmitted wireless signals. The wireless communication control apparatus can accordingly cover all frequency channels without requiring the extra circuitry that would be needed to receive signals on all frequency channels simultaneously.

The invention also provides a wireless system including anchor nodes with wireless communication control apparatus as described above. In such a system, the scanning cycles at different anchor nodes are preferably synchronized so that all anchor nodes scan the same frequency channel simultaneously. In one synchronization scheme, when the receiving unit of an anchor node receives a series of wireless signals transmitted by the mobile device on some one frequency channel, the receiving node continues to select that frequency channel as long as the wireless signals continue to arrive, and resumes cyclic scanning of the frequency channels after the wireless signals stop arriving. The location estimation unit requests the mobile unit to keep transmitting the wireless signals until the location estimation unit has received measurement information from all anchor nodes. Subsequently, all anchor nodes resume scanning at the same point in their scanning cycle and thereafter scan in unison.

The location estimation unit or a separate data processing unit may add a predetermined quantity to the measured power values if the measured power values drop by at least a certain amount while the mobile node is engaged in a call, to compensate for reduced antenna gain at the mobile node when the mobile node is held in the user's hand.

### BRIEF DESCRIPTION OF THE DRAWINGS

In the attached drawings:

FIG. 1 is a block diagram illustrating the overall structure of a wireless network system in a first embodiment of the invention;

FIG. 2 is a block diagram illustrating the internal structure of an anchor node in the first embodiment;

FIG. 3 is a flowchart illustrating the operation of an anchor node in the first embodiment;

FIG. 4 is a timing diagram illustrating wireless channel switching operations at each anchor node in the first embodiment;

FIG. 5 is a block diagram illustrating the overall structure of a wireless network system in a second embodiment;

FIG. 6 is a flowchart illustrating the correction of received power values in the second embodiment;

FIG. 7 is a graph illustrating the correction of received power values in the second embodiment;

FIG. 8 is a block diagram illustrating the overall structure of a wireless network system in a third embodiment; and

FIG. 9 is a timing diagram illustrating wireless channel switching operations at three anchor nodes in the third embodiment.

### DETAILED DESCRIPTION OF THE INVENTION

Embodiments of the invention will now be described with reference to the attached drawings, in which like elements are indicated by like reference characters. The wireless networks in the embodiments conform to the IEEE 802.11b standard, although the invention is not limited to this or any other particular standard. The mobile node to be located will be referred to as the target node.

### First Embodiment

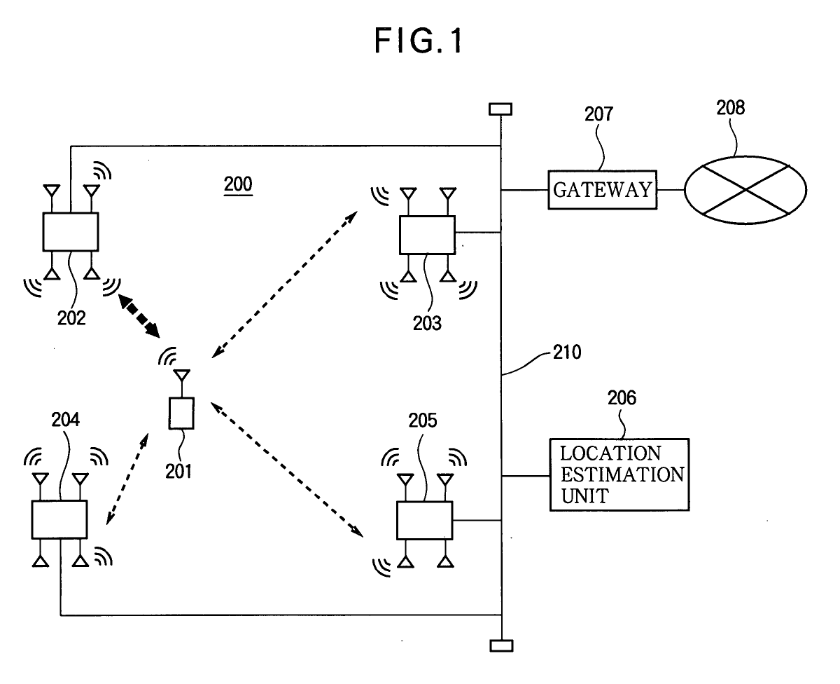

Referring to FIG. 1, the first embodiment concerns a wireless network system 200 in which the location of a mobile target node 201 is to be determined from the known locations of four anchor nodes 202-205 by a location estimation unit 206. The anchor nodes 205 are connected to each other and to the location estimation unit 206 through a wired communication line 210, which is connected through a gateway device 207 to an external network 208 such as the Internet. The anchor nodes 202-205 communicate with the target node 201 by use of four of the fourteen wireless channels (Ch1-Ch14) designated in the IEEE 802.11 standards.

Although only one target node 201 is shown in FIG. 1, there may be other mobile nodes in the system. A mobile node becomes a target node when the location estimation unit 206 attempts to determine its location.

To determine the location of a target node 201, the anchor node 205 sends the target node 201 a control signal such as the echo request signal designated in the Internet control message protocol (ICMP). The target node 201 replies by sending, for example, an ICMP echo response. Each of the anchor nodes 202-205 measures the received power of the target node's response and sends the received power value to the location estimation unit 206. From the received power values and the known positions of the anchor nodes 202-205, the location estimation unit 206 estimates the location of the target node 201.

When they are not communicating with the target node 201, the anchor nodes 202-205 periodically switch from one receiving frequency to another, thereby scanning the wireless channels used by the network.

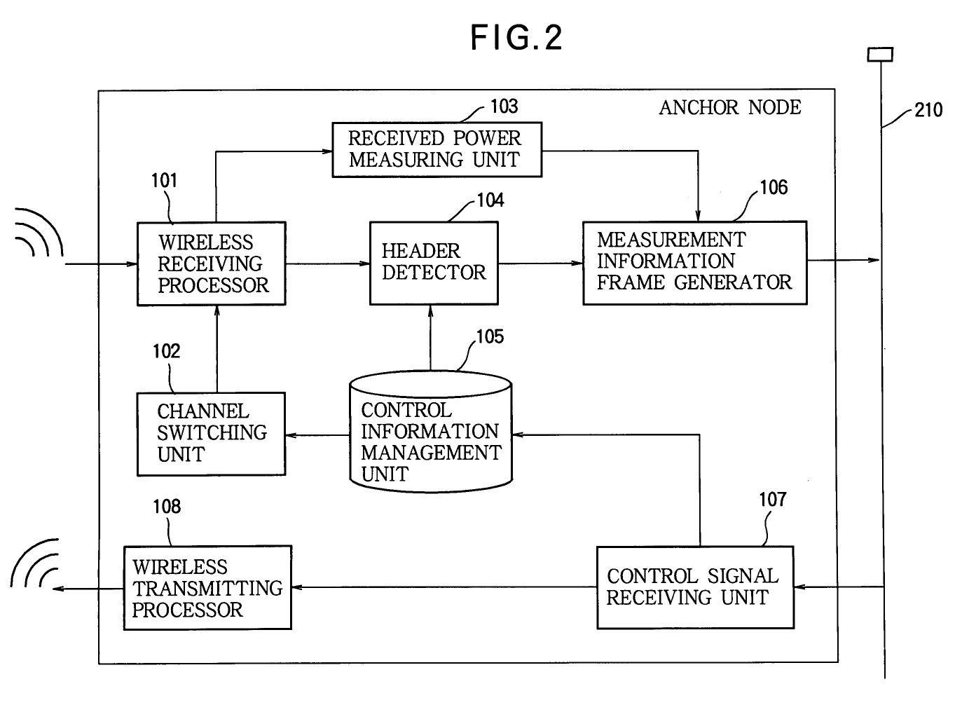

Referring to FIG. 2, each anchor node comprises a wireless receiving processor 101, a channel switching unit 102, a received power measuring unit 103, a header detector 104, a control information management unit 105, a measurement information signal generator 106, a control signal receiving unit 107, a wireless transmitting processor 108, and other components (not shown) for transmitting data between the wired and wireless parts of the network.

The wireless receiving processor 101 carries out well-known receiving processes such as frequency conversion and demodulation to obtain information transmitted by the target node 201. The information is transmitted in units referred to as frames, each consisting of a header and a body. The wireless receiving processor 101 passes each received frame to the received power measuring unit 103 and header detector 104.

The channel switching unit 102 switches the wireless channel used by the wireless receiving processor 101 according to information stored in the control information management unit 105.

The received power measuring unit 103 measures the received power of each received frame, and passes the received power value to the measurement information generator 106.

The header detector 104 reads various items of header information, including the source and destination addresses of the frame and the frame type, and compares the address information with address information obtained from the control information management unit 105.

The control information management unit 105 stores and manages information designating the address of the target node 201 to be located, the wireless channels to be scanned, and the scanning interval (S_INT). The control information management unit 105 also stores a timer value that measures the remaining time (T_REM) in each scanning interval. The timer value is decremented at a constant rate until it reaches zero.

When the source address of a received frame matches the address of the target node 201 that the location estimation unit 206 is attempting to locate, the measurement information generator 106 generates an information signal including the received power value measured by the received power measuring unit 103 and transmits the information signal to the location estimation unit 206 through the wired communication line 210.

From the location estimation unit 206 or the external network 208, the control signal receiving unit 107 receives control signals including information such as the address of a target node 201 that is to be located and the wireless channels to be used. The control signal receiving unit 107 passes this information to the control information management unit 105 or wireless transmitting processor 108 as appropriate.

The wireless transmitting processor 108 transmits control signals received by the control signal receiving unit 107 from the location estimation unit 206 to the target node 201. When the location estimation unit 206 is attempting to locate a target node 201, it sends these control signals at predetermined request intervals, the length of which will be denoted R_INT.

The elements shown in FIG. 2 comprise various memory and logic circuits, a detailed description of which will be omitted. The wireless receiving processor 101 and wireless transmitting processor 108 also include amplifiers and other analog circuits for processing radio-frequency signals. Integrated circuit devices or ‘chips’ incorporating such radio-frequency processing circuits are commercially available. It will be assumed below that each anchor node 202-205 has a plurality of such chips, one of which is used to scan the communication channels, the other one or ones being used for data communication with other nodes.

The scanning process is carried out as follows. If, for example, information designating Ch1, Ch6, Ch11, and Ch14 as the channels to be scanned is stored in the control information management unit 105, the control information management unit 105 begins by setting its timer value (T_REM) to the scanning interval (S_INT), and the channel switching unit 102 instructs the wireless receiving processor 101 to start receiving on Ch1. If no frame is received from target node 201, then at the end of the scanning interval, which is detected when the T_REM value reaches zero, the channel switching unit 102 switches the wireless receiving processor 101 from Ch1 to Ch6. After a brief channel switching interval, the control information management unit 105 sets T_REM to S_INT again and the wireless receiving processor 101 begins receiving on Ch6. The control information management unit 105, channel switching unit 102, and wireless receiving processor 101 continue operating in this way, scanning channels Ch1, Ch6, Ch11, and Ch14 cyclically as long as no frame is received from the target node 201.

When the wireless receiving processor 101 receives a frame transmitted by the target node 201, the channel switching unit 102 compares the current timer value T_REM with the request interval length R_INT. If the timer value is less than the request interval length (T_REM<R_INT), the control information management unit 105 adds R_INT to the timer value, and continues to do so in each subsequent request interval. As long as the location estimation unit 206 continues to send control signals, accordingly, the timer value. (T_REM) never reaches zero and the wireless receiving processor 101 keeps receiving on the same channel. When the location estimation unit 206 stops sending control signals and the target node 201 stops sending replies, after the timer value falls to zero, the channel switching unit 102 switches the wireless receiving processor 101 to the next channel to resume the scanning process.

The request interval R_INT is preferably shorter than the scanning interval S_INT. The location estimation unit 206 may be initially set to continue sending control signals for a length of time sufficient for each anchor node to complete one full scan of the channels. In the present case, for example, since there are four channels, the location estimation unit 206 may be set to send control signals for the period from the beginning of the scanning of the first channel to the end of the scanning of the fourth channel.

Even if the four anchor nodes 202-205 do not initially scan the channels in unison, their scanning cycles become synchronized during the scanning process, as described below, and once synchronization is achieved, it is maintained. Therefore, the location estimation unit 206 may also be adapted to decide when the anchor nodes' scanning cycles have been synchronized and then synchronize the sending of its control signals with the scanning cycles, so that the location estimation process can be completed without the transmission of more control signals than necessary.

Next, the operation of the first embodiment will be described in more detail, again assuming that the channels used for communication by the anchor nodes 202-205 are Ch1, Ch6, Ch11, and Ch14, and assuming that the target node 201 communicates on Ch11.

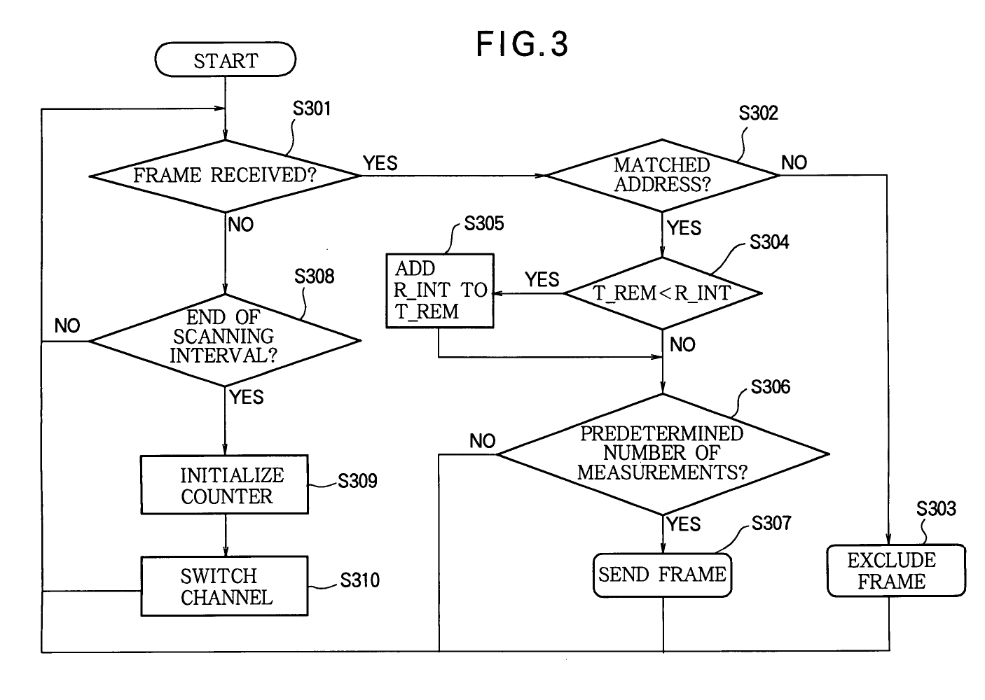

During the scanning process, each anchor node operates according to the flowchart in FIG. 3.

After being set to select a particular frequency channel by the channel switching unit 102, the wireless receiving processor 101 decides whether it has received a frame (step S301).

If a frame has been received, the received power measuring unit 103 measures the received power of the frame and the header detector 104 decides whether the address information in the frame matches address information stored in the control information management unit 105 (step S302).

If the address information does not match, indicating that the frame was not transmitted from the target node 201, the frame is excluded from the location estimation process (step S303) and the process returns to step S301.

If the address information matches, the control information management unit 105 compares the timer value T_REM with the request interval R_INT (step S304). If T_REM is less than R_INT, the control information management unit 105 adds R_INT to T_REM (step S305).

At the same time, the measured received power value is stored in the measurement information generator 106. The measurement information generator 106 keeps a separate record of the measured received power values for each target node and compares the number of measured values with a predetermined number N (step S306). The value of N may be set according to a necessary number of frames or a necessary time interval. If the number of measured values is less than N, the process returns to step S301 to obtain further measurements.

When the number of measured values reaches the predetermined number N, the measurement information generator 106 sends the location estimation unit 206 an information signal frame including the measured values (step S307), after which the process returns to step S301.

If a frame has not yet been received in step S301, the channel switching unit 102 checks the timer value T_REM to determine whether the current scanning interval has ended (step S308). If the scanning interval has not ended (T_REM>0), the process returns to step S301.

If the scanning interval has ended (T_REM=0), the control information management unit 105 initializes the counter value to the scanning interval by setting T_REM to S_INT (step S309), and the channel switching unit 102 switches the wireless receiving processor 101 to the next channel (step S310). The process then returns to step S301 to start scanning the next channel.

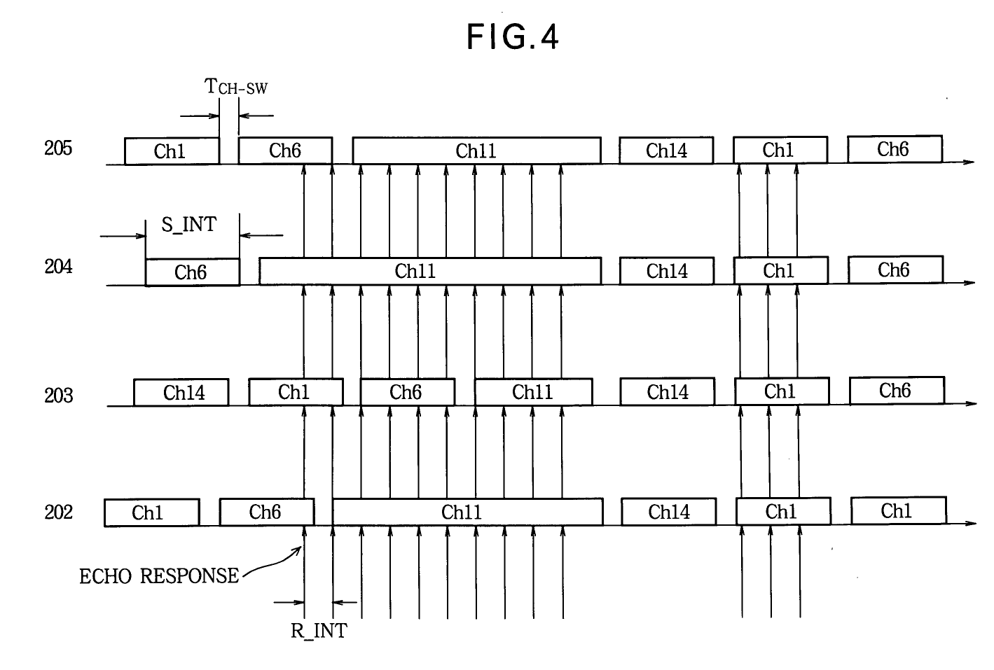

FIG. 4 illustrates the operation of all four anchor nodes 202-205 during a typical scanning process.

Initially, the target node is not transmitting. The anchor nodes 202-205 are unsynchronized and begin scanning different channels at different times. Each anchor node scans one channel for the scanning interval (S_INT), then switches receiving frequencies during a brief switching interval (T_{CH-SW}) and starts scanning the next channel in the scanning cycle, which is Ch1-Ch6-Ch11-Ch14.

In FIG. 4, the location estimation unit 206 starts sending echo request signals and the target node 201 starts returning echo response signals at a time when anchor node 204 is scanning the channel (Ch11) used by the target node 201. As long as the echo response signals continue to arrive, anchor node 204 continues to scan this channel (Ch11). At various times during the sequence of echo response signals, anchor nodes 202, 205, and 203 also begin scanning this channel, and they also continue scanning it as long as they continue receiving echo response signals.

In time, all four anchor nodes 202-205 accumulate sufficient measurement data to send to the location estimation unit 206. When the location estimation unit 206 has received enough measurement data from all four anchor nodes 202-205 to estimate the location of the target node 201, it stops sending echo request signals and the target node 201 stops sending echo response signals. Shortly after this time, the timer values (T_REM) reach zero at all four anchor nodes 202-205 simultaneously, and all four anchor nodes 202-205 switch over to scan the next channel (Ch14).

The location estimation unit 206 can now synchronize its operations with the channel scanning operations of the anchor nodes 202-205. To estimate the location of a target node using channel one (Ch1), for example, the location estimation unit 206 starts sending echo request signals when the anchor nodes 202-205 start scanning channel one (Ch1). All anchor nodes 202-205 measure the power of the received echo response signals simultaneously, and sufficient location estimation data are collected within one scanning interval.

The first embodiment has the following effects.

Since all anchor nodes scan all channels, measurement data are received from all anchor nodes, enabling the location of the target node to be estimated accurately.

Since each anchor node scans the channels cyclically, it requires only one scanning device, instead of a separate device for each channel. This arrangement reduces the size, cost, and power consumption of the anchor nodes.

Since the location estimation unit 206 can synchronize its operations with the scanning cycle of the anchor nodes, it can acquire adequate measurement data with a minimum number of control signals, thereby reducing the amount of control signal traffic that must be carried by the wireless network system 200.

Since the anchor nodes wait until they have accumulated N measurement values before sending measurement data to the location estimation unit 206, the amount of measurement data traffic is also reduced.

### Second Embodiment

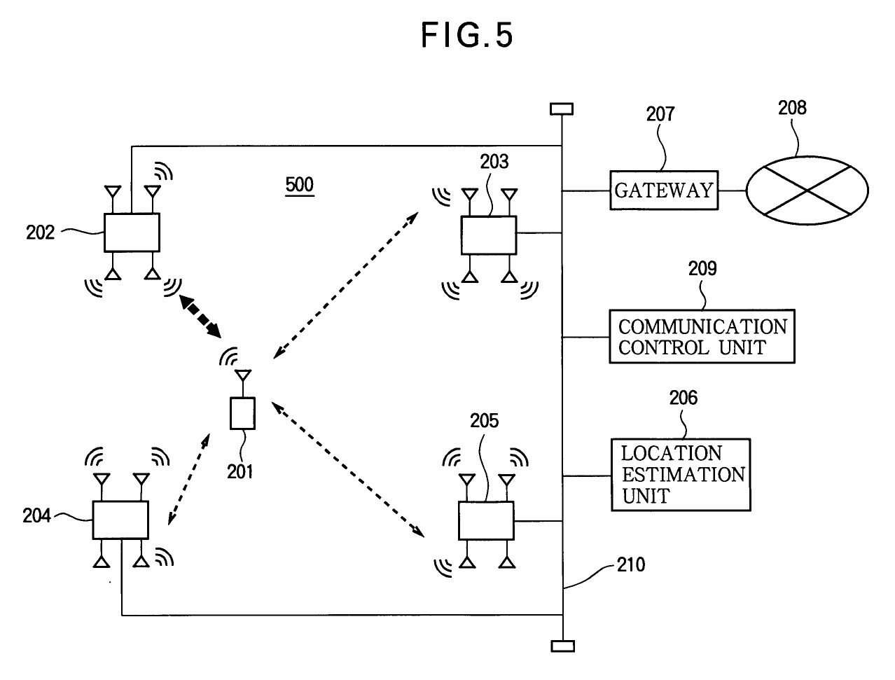

Referring to FIG. 5, the second embodiment is a wireless network system 500 comprising a target node 201, four anchor nodes 202-205 that operate as described in the first embodiment, a location estimation unit 206, a gateway device 207 that links the wireless network system 500 to an external network such as the Internet 208, and a communication control unit 209 that performs call control functions such as setting up communication sessions between communicating nodes.

The location estimation unit 206 operates substantially as described in the first embodiment, except that it modifies the power measurement data received from the anchor nodes 202-205 according to changes in the measurement data and call control information provided by the communication control unit 209.

Changes in the received power measurement data occur because of motion of the target node 201 from one location to another, but such changes may also occur because of other factors. For example, if the target node 201 is held in the user's hand while the user is making a call, the user's hand tends to absorb some of the power of the measurement signals transmitted from the antenna of the target node 201, lowering the antenna gain. When a drop in measured signal power occurs at or shortly before the beginning of a call, the cause of the drop is likely to be the user's hand or some similar external factor, unrelated to the location of the target node 201. The location estimation unit 206 modifies the measurement data to correct for the effects of such external factors.

More specifically, the location estimation unit 206 compares the received power data currently provided by the anchor nodes 202-205 for a target node 201 with the most recent received power data provided previously by the anchor nodes 202-205 for the same target node 201. If the current received power value is less than the previous received power value, the location estimation unit 206 compares the difference with a threshold value. The threshold value may be predetermined through experiments that measure the reduction in received power that occurs when the target node 201 is held in the user's hand. If the difference is less than the threshold value, the location estimation unit 206 estimates the location of the target node 201 by using the measurement data as received.

If the difference is greater than the threshold value, the location estimation unit 206 queries the communication control unit 209 to determine whether the target node 201 is currently engaged in a call. If target node 201 is currently engaged in a call, then the measured data are modified by adding a predetermined amount as a correction that compensates for the experimentally determined effect of the user's hand, and the location estimation unit 206 proceeds to estimate the location of the target node 201 from the modified measurement data.

The location estimation unit 206 then continues to modify the received measurement data until the end of the call, as determined by querying the communication control unit 209, or by querying the target node 201 directly. Alternatively, the communication control unit 209 may automatically notify the location estimation unit 206 of the termination of the call without having to be queried.

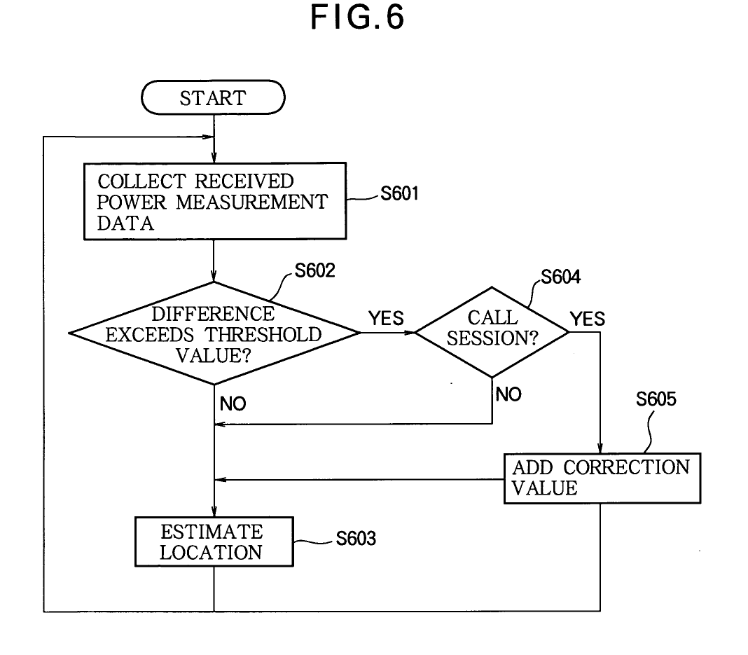

FIG. 6 summarizes the data modification process performed by the location estimation unit 206. After obtaining received power measurement data for the target node 201 from a particular anchor node, say, anchor node 202 (step S601), the location estimation unit 206 takes the difference between the received data and the previous measurement data received for the same target node 201 from the same anchor node 202, and compares the difference with the predetermined threshold value (step S602). If the difference is equal to or less than the threshold value, the location estimation unit 206 proceeds with location estimation (step S603). If the difference exceeds the threshold value, the location estimation unit 206 queries the communication control unit 209 to find out if the target node 201 is currently engaged in a call, that is, if it is communicating with another node with which it has established a call session under the control of the communication control unit 209 (step S605). If the target node 201 is not currently engaged in a call, the location estimation unit 206 proceeds with location estimation (step S603). If the target node 201 is currently engaged in a call, the location estimation unit 206 modifies the measurement data by adding a predetermined correction value (step S605) and then proceeds to location estimation (step S603), using the modified data.

Although not explicitly indicated in FIG. 6, once the modification in step S604 has been made, in processing further measurement data concerning target node 201 received from anchor node 202, the location estimation unit 206 skips step S602 and proceeds directly from step S601 to step S604 until a ‘No’ result is obtained in step S604. That is, the correction value continues to be added to further measurement data concerning target node 201 received from anchor node 202 until the call has ended.

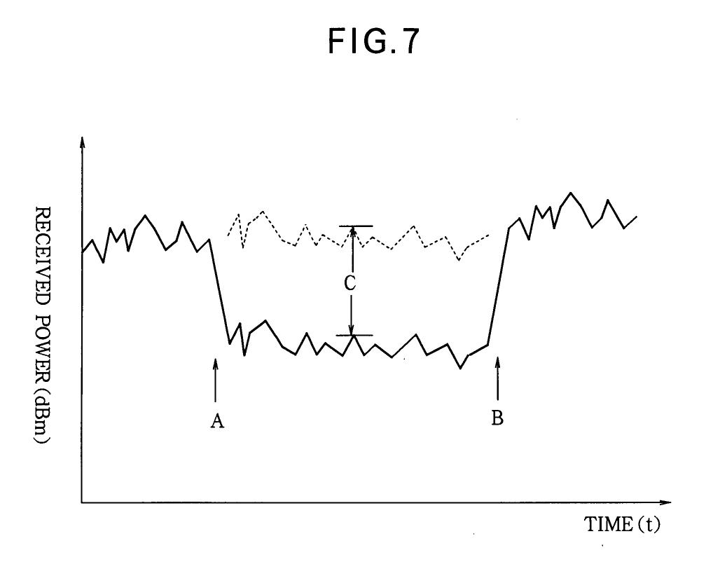

This process is illustrated in FIG. 7. Time is indicated on the horizontal axis and received power on the vertical axis. The solid line indicates the measurement data received from anchor node 202. The target node 201 begins a call at time A, and the call ends at time B. The sharp drop in measured power values at time A exceeds the predetermined threshold, so during the call, the location estimation unit 206 adds the correction value C to the measurement data. Consistent measurement data are thereby obtained before, during, and after the call, which aids in accurate location estimation.

The second embodiment provides the same effects as the first embodiment, with the additional effect of compensating for the drop in antenna gain caused by the user's hand. This effect is particularly important when the target node 201 communicates with the anchor nodes 202-205 by means of an internal antenna, which is likely to be surrounded more or less completely by the user's hand and other parts of the user's body during a call. Many mobile phones now use internal antennas for communication with local area networks such as the wireless network system 500 in FIG. 5, and can accordingly benefit from the correction applied in the second embodiment.

In a variation of the second embodiment, the data correction process shown in FIGS. 6 and 7 is carried out not by the location estimation unit 206 itself but by a separate information processing device connected to the location estimation unit 206 by a connector or cable, for example. This information processing device may be a device that receives measurement data from the anchor nodes, processes the measurement data, and supplies the processed measurement data to the location estimation unit 206.

The information processing device may be, for example, a general-purpose computing device with a central processing unit, read-only memory, random access memory, and other well-known facilities such as an electrically erasable programmable read-only memory and rotating disk memory. The information processing device may be configured to carry out the measurement data modification process in FIG. 6 by installation of a suitable data modification program in one of its memory facilities.

Alternatively, both the location estimation unit 206 and the information processing device may be incorporated into a general-purpose computing device in this way, or the information processing device may be incorporated into each of the anchor nodes 202-205.

An information processing device of this type can be usefully employed in any wireless system in which calls are made from mobile nodes and the positions of the mobile nodes are determined by measuring the power of signals received from the mobile nodes at a plurality of other nodes (e.g., anchor nodes), regardless of whether these other nodes scan communication channels or not. For example, each anchor node in FIG. 5 may receive measurement signals on only a single wireless channel.

### Third Embodiment

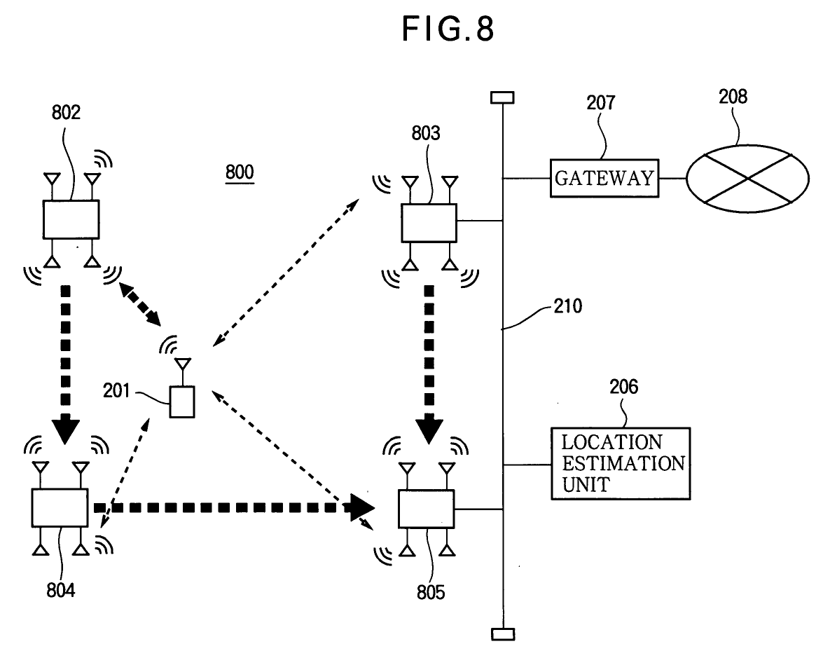

Referring to FIG. 8, the third embodiment is a multi-hop wireless network system 800 in which the anchor nodes 802-805 communicate with each other over wireless links. Only anchor node 805 is connected to the wired part of the network. The target node 201, location estimation unit 206, gateway device 207, and external network 208 are the same as in the first embodiment.

The anchor nodes 802-805 scan the frequency channels and measure received power values as described in the first embodiment. The difference is in the way they send the measurement data to the location estimation unit 206. Anchor node 805 sends its measurement data directly to the location estimation unit 206 over the wired communication line 210, but anchor nodes 803 and 804 relay their measurement data to the location estimation unit 206 through anchor node 805, and anchor node 802 relays its measurement data to the location estimation unit 206 through anchor nodes 804 and 805.

The data relay process is carried out according to a communication protocol given in the IEEE 802.11 standards. When anchor node 802, 803, or 804 has measurement data to send, it first transmits a request to send (RTS) signal to its surrounding nodes, specifying the address of the anchor node that is to act as the next relay node. The address may be specified as, for example, a medium access control (MAC) address. The addressed anchor node returns a clear to send (CTS) signal, receives the measurement data, and then returns an acknowledgement (ACK) signal. This completes the first hop of the data relay. If necessary, subsequent hops are carried out in the same way.

The RTS signal includes a duration field that specifies the time period during which the transmitting node intends to transmit its measurement data frame. An anchor node that receives the RTS signal may not transmit during the specified time period. During the specified time period, however, the anchor node may continue to scan channels other than the channel used for the measurement data transmission and measure the received power of echo response signals on the scanned channels.

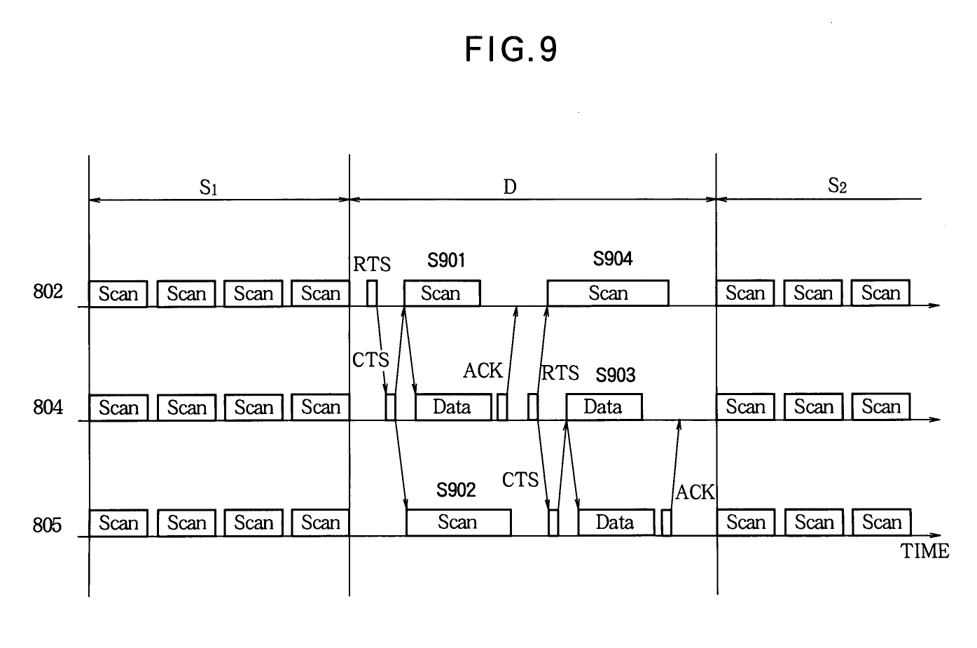

The data relay operation is illustrated in FIG. 9 for the case in which anchor node 802 transmits measurement data to the location estimation unit 206 via anchor nodes 804 and 805.

During an initial period S1, anchor nodes 802, 804, and 805 scan channels and accumulate measurement data from target node 201 as described in the first embodiment. At the end of this period, anchor node 802 has accumulated enough measurement data to send to the location estimation unit 206, so anchor node 802 transmits an RTS signal to anchor node 804. Anchor node 804 replies with a CTS signal, and anchor node 802 proceeds to transmit its measurement data (step S901). Anchor node 804 receives the measurement data and replies with an ACK signal.

Anchor node 805 also receives the CTS signal from anchor node 804, but since anchor node 805 is not specified as the data transmitting node, during the data transmission anchor node 805 continues to scan channels other than the channel used for the data transmission (step S902).

Anchor node 804 then sends an RTS signal to anchor node 805. Anchor node 805 stops scanning the channels and replies with a CTS signal. Anchor node 804 now transmits the measurement data it received from node 802 (step S903). Anchor node 805 receives the measurement data and replies with an ACK signal. Anchor node 802 also receives the RTS signal from anchor node 804, but since anchor node 802 is not specified as the data receiving node, anchor node 802 begins scanning the channels other than the transmitting channel used by anchor node 804 (step S904).

Throughout substantially all of the measurement data relay period D, channel scanning continues by at least one of the three anchor nodes 802, 804, 805 involved in the relay. Anchor node 803 (not shown) also continues scanning channels during this period D, avoiding the channel currently being used to transmit the measurement data.

After the ACK signal transmitted by anchor node 805, no further relay is necessary, so in the following period S₂ all the anchor nodes resume normal synchronous scanning of all channels.

Installing a wired anchor node such as anchor node 805 and connecting it to the wired communication line 210 is generally more expensive then installing purely wireless anchor nodes such as anchor nodes 802, 803, 804. The wireless network system 800 in the third embodiment can therefore be set up at a lower cost than the wireless network systems 200, 500 in the preceding embodiments, in which all anchor nodes used both wired and wireless communication.

The RTS-CTS-ACK protocol followed in the third embodiment enables anchor nodes to communicate with each other without data collisions. In addition, by using the RTS, CTS, and ACK signals to synchronize their channel scanning operations, a purpose not envisioned in the RTS-CTS-ACK protocol, the anchor nodes can continue limited channel scanning while a data transfer between two anchor nodes is taking place, thereby increasing the rate at which received power measurement data are obtained.

The use of the RTS, CTS, and ACK signals for scanning synchronization also enables the anchor nodes to maintain scanning channel synchronization. In period D in FIG. 9, for example, anchor nodes 803 and 805 can scan the same channel or channels during step S902, and anchor nodes 802 and 803 can scan the same channel or channels during step S904.

In a multi-hop network, an echo response signal transmitted by a target node may make several hops, passing through several anchor nodes en route to the location estimation unit. The received power is measured only on the first hop.

Although the preceding embodiments are based on the frame transmission scheme described in the IEEE 802.11b standard for wireless LANs, the invention can be practiced in a wide variety of wireless network systems, including systems complying with the IEEE 802.15 standards for personal area networks or the IEEE 802.16 standards for metropolitan area networks.

In a variation of any of the preceding embodiments, the anchor nodes synchronize their channel scanning operations be means of synchronizing signals issued from the location estimation unit, instead of by operating on the timer values (T_REM). For example, if the scanning sequence is Ch1-Ch6-Ch11-Ch14, all anchor nodes can start scanning channel one (Ch1) when they receive a synchronization signal from the location estimation unit.

In another exemplary scheme, the synchronizing signal transmitted by the location estimation unit designates an initialization time, and the anchor nodes initialize their scanning cycles at the designated time.

In yet another possible synchronization scheme, the anchor nodes operate on their timer values (T_REM) not only according to the relation of the timer value to a threshold value, but also to the frame type. For example, the control information management unit 105 may be adapted to add the R_INT value to the T_REM value only when the received frame is an ICMP echo response frame. This scheme enables the anchor nodes to continue scanning channels while the target node is transmitting other types of frames, such as data transmission frames or voice communication frames. It also helps the location estimation unit to control the scanning timing by transmitting ICMP echo request signals at appropriate times, because when the location estimation unit is not transmitting ICMP echo request signals, the target node will not transmit ICMP echo response signals, so the anchor nodes will interrupt their scanning cycles only at times that the location estimation unit can control by sending ICMP echo request signals.

Operations on the timer values may also be made dependent on the original source address of the received frame, the port number of the received frame, or the data carried in the body of the frame.

In another variation, the location estimation process is carried out by an anchor node, or by the target node itself, instead of by a separate location estimation unit.

In yet another variation, some of the anchor nodes are mobile nodes. Their locations may be known from previous estimation, or may be estimated together with the location of the target node. In other words, the locations of two or more mobile nodes may be estimated simultaneously, and the received power of wireless signals transmitted between the mobile nodes may also be used in the estimation process.

Those skilled in the art will recognize that further variations are possible within the scope of the invention, which is defined in the appended claims.

What is claimed is:

1. A wireless communication control apparatus used in at least one of a plurality of anchor nodes in a wireless system having a location estimation unit for estimating a location of a mobile node (201) from wireless signals transmitted from the mobile node to the anchor nodes on one of a plurality of frequency channels, comprising:
a receiving unit for cyclically selecting the plurality of frequency channels at prescribed intervals and receiving the wireless signals, if any, transmitted from the mobile node in the selected frequency channel;
a received power measurement unit for measuring received power of the wireless signals received by the receiving unit; and
a measurement information generator for transmitting information indicating the received power measured by the received power measurement unit to the location estimation unit.

2. The wireless communication control apparatus of claim 1, further comprising a control information management unit for storing information indicating the plurality of frequency channels and a sequence in which the plurality of frequency channels are to be selected by the receiving unit.

3. The wireless communication control apparatus of claim 1, wherein, when the receiving unit receives a wireless signal from the mobile node during the prescribed interval for which said one of the plurality of frequency channels is selected, the receiving unit selectively extends the prescribed interval.

4. The wireless communication control apparatus of claim 3, wherein the receiving unit measures time remaining in the prescribed interval and selectively extends the prescribed interval by adding a predetermined length of time to the time remaining in the prescribed interval if the time remaining in the prescribed interval is less than the predetermined length of time.

5. The wireless communication control apparatus of claim 4, wherein the predetermined length of time is shorter than the prescribed interval.

6. The wireless communication control apparatus of claim 4, wherein the predetermined length of time is equal to an interval at which the mobile node transmits the wireless signals.

7. The wireless communication control apparatus of claim 1, wherein the measurement information generator accumulates a predetermined number of received power measurement values from the received power measurement unit, then sends the predetermined number of received power measurement values to the location estimation unit in a single information signal.

8. The wireless communication control apparatus of claim 1, wherein the receiving unit adaptively modifies the plurality of frequency channels to exclude any frequency currently being used by one of the plurality of anchor nodes to transmit data to another one of the plurality of anchor nodes.

9. The wireless communication control apparatus of claim 8, wherein the plurality of anchor nodes transmit data to each other according to a protocol with protocol control signals, and the receiving unit synchronizes its selection of the frequency bands with the protocol control signals.

10. A node comprising including the wireless communication control apparatus of claim 1.

11. A wireless system including a plurality of anchor nodes, a mobile node, and a location estimation unit, each of the anchor nodes comprising:
a receiving unit for cyclically selecting a plurality of frequency channels at prescribed intervals and receiving wireless signals transmitted from the mobile node in the selected frequency channel;
a received power measurement unit for measuring received power of the wireless signals received by the receiving unit; and
a measurement information generator for transmitting information indicating the received power measured by the received power measurement unit to the location estimation unit; wherein
the location estimation unit uses the information transmitted by the measurement information generator in each one of the plurality of anchor nodes to estimate a location of the mobile node.

12. The wireless system of claim 11, wherein the location estimation unit modifies said information according to changes in the received power and a status of communication between the mobile node and the plurality of anchor nodes.

13. The wireless system of claim 12, wherein the location estimation unit adds a first quantity to the measured power while the mobile node is engaged in communication with one of the plurality of anchor nodes if the measured power drops by at least a second quantity during the communication.

14. The wireless system of claim 12, further comprising a communication control unit for performing call control, wherein the location estimation unit adds a first quantity to the measured power while the mobile node is engaged in a call under control of the communication control unit if the measured power drops by at least a second quantity during the call.

15. An information processing device for use in a wireless system having a mobile node, a plurality of anchor nodes, and a location estimation unit for estimating a location of the mobile node from information received from the plurality of anchor nodes, the information indicating received power of wireless signals transmitted from the mobile node to the plurality of anchor nodes, the information processing device modifying the information according to changes in the received power and a status of communication between the mobile node and the plurality of anchor nodes.

16. The information processing device of claim 15, wherein the information processing device adds a first quantity to the measured power while the mobile node is engaged in communication with one of the plurality of anchor nodes if the measured power drops by at least a second quantity during the communication.

17. The information processing device of claim 15, wherein the wireless system includes a communication control unit for performing call control and the location estimation unit adds a first quantity to the measured power while the mobile node is engaged in a call under control of the communication control unit if the measured power drops by at least a second quantity during the call.
